(19) United States
(12) Patent Application Publication
(10) Pub. No.: US 2026/0051688 A1
(43) Pub. Date: Feb. 19, 2026

(54) CONNECTOR

(71) Applicant: Yazaki Corporation, Tokyo (JP)

(72) Inventors: Hideki Saito, Shizuoka (JP); Hiromasa Kubota, Shizuoka (JP)

(73) Assignee: Yazaki Corporation, Tokyo (JP)

(21) Appl. No.: 19/291,844

(22) Filed: Aug. 6, 2025

(30) Foreign Application Priority Data
Aug. 13, 2024 (JP) 2024-134928

(51) Int. Cl. H01R 13/436

(52) U.S. Cl. CPC H01R 13/4362

(57) ABSTRACT

A retainer of a connector includes a block-shaped terminal holding part which is freely movable in and out of an internal space of the cavity in accordance with sliding of the retainer and which locks a terminal metal part when facing a locking surface forming a part of the terminal metal part in the accommodation direction, and a reinforcing rib provided integrally with a side surface of the terminal holding part, the sliding direction being the normal direction of the side surface. An upper surface of the reinforcing rib is set so that a minimum distance in a height direction between the upper surface and a lower end of a locking surface of the terminal metal part accommodated in the cavity is set to be the minimum within an allowable range in which accommodation of the terminal metal part is not prevented.

### CROSS REFERENCE TO RELATED APPLICATION

The present application is based on, and claims priority from the Japanese Patent Application No. 2024-134928, filed on Aug. 13, 2024, the entire contents of which are incorporated herein by reference.

### TECHNICAL FIELD

The present disclosure relates to a connector.

### BACKGROUND

Conventionally, there is a connector including a housing having a cavity (terminal accommodating chamber) for accommodating a terminal metal part. Japanese Patent Application Publication No. 2010-73375 discloses a technique for a connector employing a double locking mechanism in which the terminal metal part is primarily locked using a lance, and the terminal metal part is secondarily locked using a secondary locking portion provided on a retainer inserted from the side of the housing.

### SUMMARY OF THE INVENTION

In the connector disclosed in Japanese Patent Application Publication No. 2010-73375, the secondary locking portion serving as the terminal holding part in the retainer is merely a block-shaped projection. Therefore, when the terminal metal part accommodated in the cavity in a state of secondary locking is pulled away from the cavity by an external force, the secondary locking portion may deform depending on the degree of the force received from the terminal metal part.

An object of the present disclosure is to provide a connector which reduces deformation of a terminal holding part in a retainer caused by an external force.

A connector according to an aspect of an embodiment includes a housing having a cavity for accommodating a terminal metal part; and a retainer slidably attachable and detachable to and from the housing in a sliding direction orthogonal to an accommodation direction of the terminal metal part, in which the retainer includes a block-shaped terminal holding part which is freely movable in and out of an internal space of the cavity in accordance with sliding of the retainer, and which locks the terminal metal part when facing a locking surface forming a part of the terminal metal part in the accommodation direction, and a reinforcing rib provided integrally with a side surface of the terminal holding part, the sliding direction being a normal direction; a height direction in which the heights of the terminal holding part and the reinforcing rib are defined is orthogonal to both the accommodation direction and the sliding direction; and an upper surface of the reinforcing rib is set so that a minimum distance in the height direction between the upper surface and a lower end of a locking surface of the terminal metal part accommodated in the cavity is set to be the minimum within an allowable range in which accommodation of the terminal metal part is not prevented.

According to the configuration above, it is possible to provide a connector which reduces deformation of the terminal holding part of the retainer caused by an external force.

### BRIEF DESCRIPTION OF THE DRAWINGS

FIG. 1 is a perspective view of a connector according to one embodiment.

FIG. 2 is an exploded perspective view of the connector according to one embodiment.

FIG. 3 is a front view of the connector when a retainer is temporarily locked.

FIG. 4 is a front view of the connector when the retainer is fully locked.

FIG. 5 is a cross-sectional view of the connector corresponding to a V-V section in FIG. 4.

FIG. 6 is a partially enlarged view of the connector corresponding to a VI section in FIG. 5.

FIG. 7 is a perspective view of the retainer.

FIG. 8 is a cross-sectional view of the connector when the retainer is temporarily locked.

FIG. 9 is a partially enlarged view of the connector corresponding to part IX of FIG. 8.

FIG. 10 is a cross-sectional view of the connector when the retainer is fully locked.

FIG. 11 is a partially enlarged view of the connector corresponding to part XI of FIG. 10.

### DETAILED DESCRIPTION OF THE INVENTION

Hereinafter, the connector according to one embodiment will be described in detail with reference to the drawings. The dimensional ratios in the drawings are exaggerated for the sake of explanation and may differ from the actual ratios.

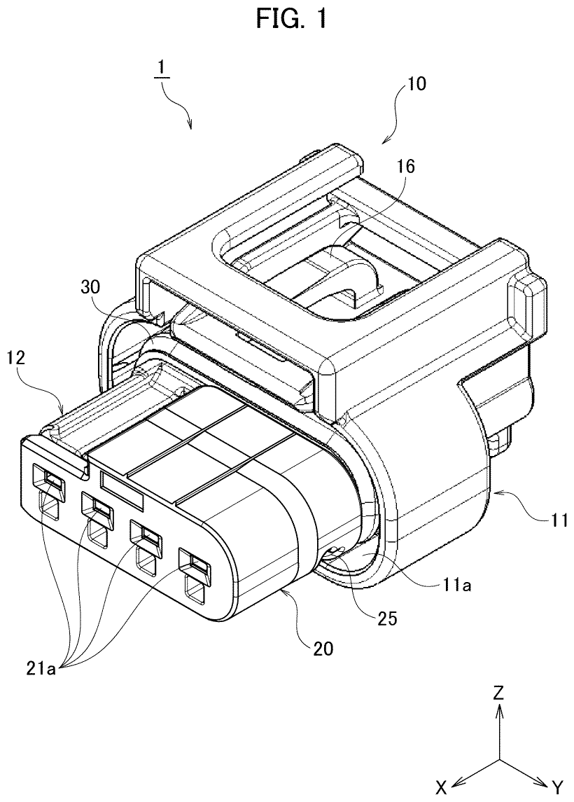

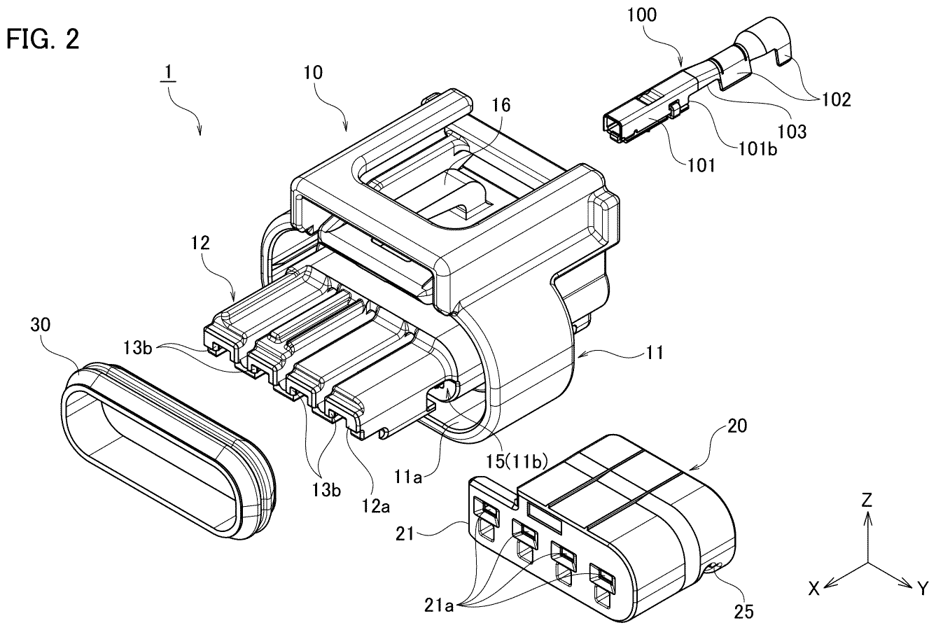

FIG. 1 is a perspective view of a connector 1 according to one embodiment. FIG. 2 is an exploded perspective view of the connector 1.

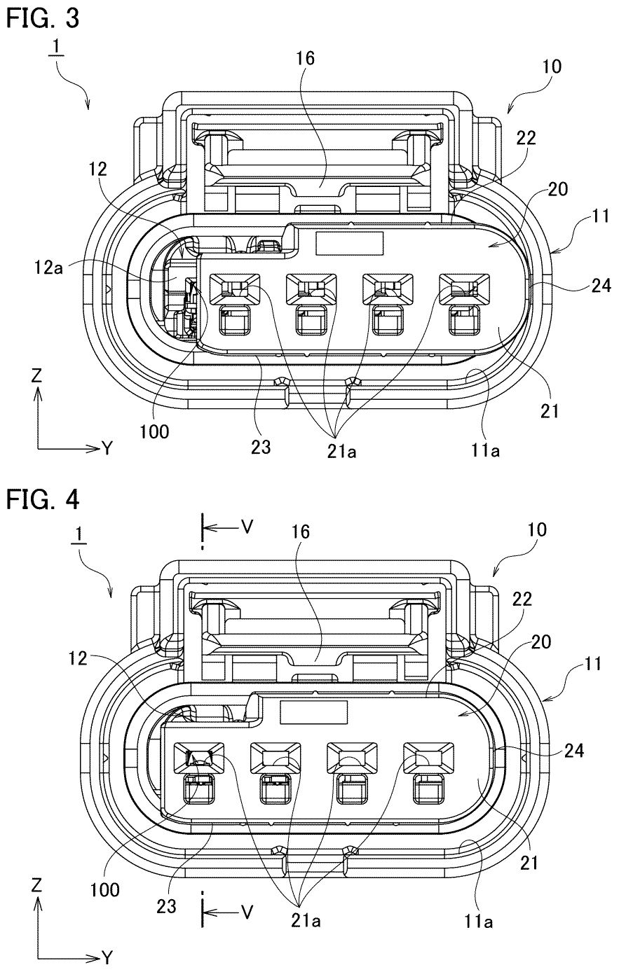

FIGS. 3 and 4 are front views of the connector 1 viewed in a direction opposite to a connection direction to a mating connector to be connected. FIG. 3 illustrates the connector 1 when a retainer 20 is temporarily locked. FIG. 4 illustrates the connector 1 when the retainer 20 is fully locked. The temporarily locked state and the fully locked state of the retainer 20 will be described in detail below.

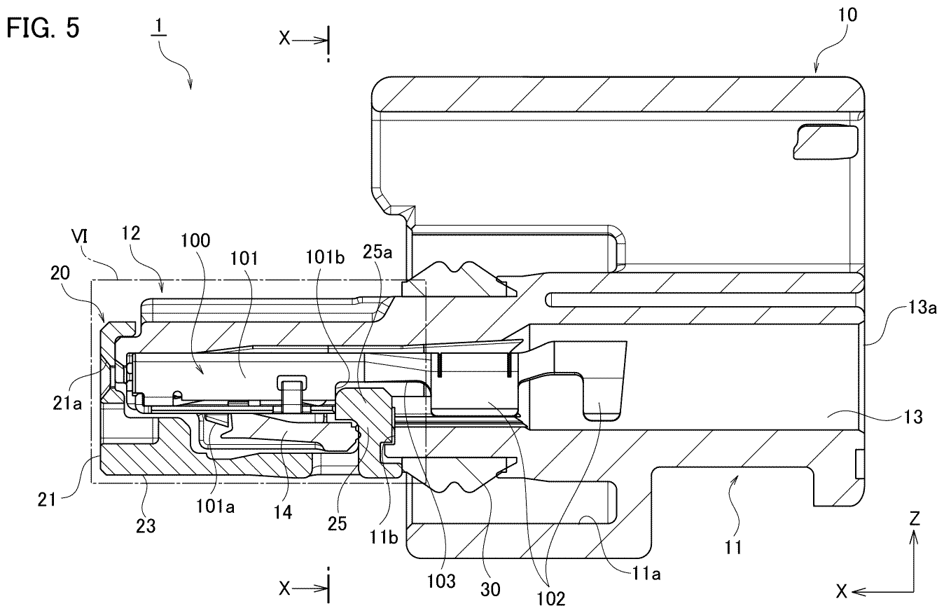

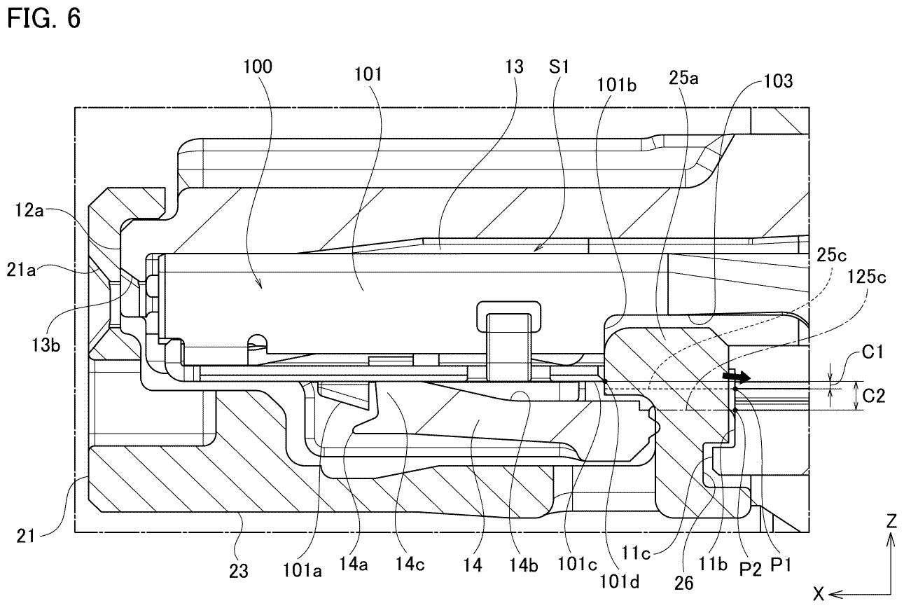

FIG. 5 is a cross-sectional view of the connector 1 corresponding to a V-V section of FIG. 4. FIG. 6 is a partially enlarged view of the connector 1 corresponding to a VI section of FIG. 5. However, in FIGS. 5 and 6, a terminal metal part 100 is illustrated in a side view for convenience.

The connector 1 is applied, for example, as a connector for an automobile, to electrically connect electrical components, such as between a power source and an apparatus or between an apparatus and another apparatus. The connector 1 is electrically connected to one electrical component and fitted with a mating connector (not illustrated) that is electrically connected to the other electrical component. In this embodiment, it is assumed that the mating connector is a male connector and the connector 1 is a female connector. One or more electric wires (not illustrated) electrically connected to the electrical component are connected to the connector 1 through the terminal metal part 100.

The terminal metal part 100 is a rod-shaped conductive member and is connected to a terminal portion of an electric wire. The terminal metal part 100 includes a connection portion 101, a joint 102, and an intermediate portion 103.

The connection portion 101 is connected to the mating terminal of a mating connector from outside. A tab-shaped mating connection portion is provided at the mating terminal and can be inserted into the connection portion 101 having a box-like shape, for example. An elastic piece having a contact for contacting the mating connection portion is provided inside the connection portion 101. A locking portion 101a (see FIG. 6) which can be engaged with a locking protrusion 14c of a lance 14 described below is formed on an outer surface of the connection portion 101 and projects outward. A part of an end edge of the connection portion 101 facing the joint 102 forms a locking surface 101b (see FIG. 6) which is locked to an engagement portion 25 of the retainer 20 described below.

The joint 102 connects electric wires. The joint 102 includes a conductor crimping portion including a pair of swaging pieces, and a covering fixation portion including a pair of swaging pieces. The conductor crimping portion is crimped to the conductor of the electric wire by swaging the pair of swaging pieces, and the terminal metal part 100 is electrically connected to the electric wire. The covering fixation portion is fixed to the cover of the electric wire by swaging the pair of swaging pieces, and the terminal metal part 100 is fixed to the electric wire.

The intermediate portion 103 is located between the connection portion 101 and the joint 102, and integrates the connection portion 101 and the joint 102. A portion of an end edge of the connection portion 101, excluding a part that is continuous with the intermediate portion 103 forms the locking surface 101b.

The connector 1 includes a housing 10, the retainer 20, and a packing 30.

In this embodiment, the terminal metal part 100 is accommodated in a cavity 13 formed in the housing 10. Hereinafter, the direction (hereinafter referred to as “accommodation direction”) in which the terminal metal part 100 is accommodated in the cavity 13 is defined as an X direction. The X direction is aligned with a length direction of the housing 10. A Y direction and a Z direction are orthogonal to the X direction and orthogonal to each other. In this embodiment, the Y direction is aligned with a width direction of the housing 10. The Z direction aligned with a height direction of the housing 10. In this embodiment, for convenience, the Z direction is oriented from bottom to top. Hereinafter, the term “up” or “down” may be used concerning the Z direction as defined.

In this case, the connection direction of the connector 1 to a mating connector corresponds to the X direction. The cutting plane in FIG. 5 is an imaginary XZ plane passing through the center in the Y direction of one cavity 13, in which the terminal metal part 100 is inserted as an example, from among the four cavities 13.

The housing 10 is a housing member formed of an insulating material such as a synthetic resin and fitted to the mating housing of the mating connector. As in this embodiment, a housing in which the connector is a female connector may be called a female housing.

The housing 10 has a housing body 11 and a connection end 12. The housing body 11 integrally supports the connection end 12 in the X direction, and has a fitting opening 11a or the like for fitting with the mating housing. The connection end 12 is located closer to the mating connector than the housing body 11 in the X direction when the connector 1 is fitted with the mating connector. The connection end 12 is connected to the connection opening of the mating connector via the retainer 20.

The housing 10 further includes a cavity 13, a lance 14, a retainer opening 15, and a lock arm 16.

The cavity 13 is an accommodating part having an elongated internal space S1 formed in the X direction, and accommodates the terminal metal part 100. The terminal metal part 100 is inserted into the cavity 13 in an orientation with an extension direction of the terminal metal part 100 aligned with the X direction. A plurality of cavities 13 are arranged in the Y direction. In this embodiment, there are four cavities 13. In other words, the housing 10 can connect four terminal metal parts 100 corresponding to four electric wires at a maximum. FIGS. 1 to 11 illustrate states in which the terminal metal parts 100 are accommodated only in one cavity 13, which is located at the innermost side in the sliding direction when the retainer 20 is attached to the housing 10, from among the four cavities 13.

An opening on the downstream side of the cavity 13 in the X direction is an accommodating opening 13a for accommodating the terminal metal part 100 in the cavity 13. Although not illustrated, after the terminal metal part 100 is accommodated in the cavity 13, the electric wire connected to the terminal metal part 100 is pulled out from the accommodating opening 13a of the housing 10. An opening on the upstream side of the cavity 13 in the X direction is a connection opening 13b for inserting the mating connection portion of the mating terminal provided in the mating connector when the connector 1 is fitted to the mating connector. The connection opening 13b is formed on a tip end face 12a of the connection end 12. An opening edge of the connection opening 13b may be a tapered surface inclined toward the cavity 13 from outside in order to facilitate insertion of the mating connection portion.

The lance 14 locks the terminal metal part 100 accommodated in the cavity 13. In this embodiment, the lance 14 is provided on the lower side of the connection end 12 in the Z direction. The lance 14 extends in the X direction with a tip end 14a on the upstream side as a free end. The lance 14 is shaped to elastically deform in a direction in which the lance 14 moves away from the cavity 13 by receiving an external force. The direction in which the lance 14 moves away from the cavity 13 is approximately in the Z direction from an upper side to a lower side. The lance 14 has a locking protrusion 14c located on the inner surface 14b facing the cavity 13. The locking protrusion 14c projects in the Z direction on the side of the tip end 14a of the lance 14 in the X direction. When the terminal metal part 100 is accommodated in the cavity 13, the locking protrusion 14c faces the locking portion 101a, which is a part of the terminal metal part 100, in the X direction.

Here, when the terminal metal part 100 is inserted into the cavity 13 with the internal space S1 being empty, the locking portion 101a comes into contact with the locking protrusion 14c of the lance 14 as the terminal metal part 100 is inserted, and the lance 14 elastically deforms to move away from the cavity 13. Subsequently, the terminal metal part 100 is further inserted, and the locking portion 101a passes over the locking protrusion 14c, thereby restoring the shape of the lance 14 toward the cavity 13. Finally, the terminal metal part 100 is placed in a normal position of the cavity 13. In the normal position, the locking portion 101a and the locking protrusion 14c face each other at a close distance in the X direction, so that the terminal metal part 100 is accommodated in the cavity 13 in a state in which it is prevented from coming out of the cavity 13.

When the retainer 20 is attached to the connection end 12, the engagement portion 25 provided on the retainer 20 slides into the retainer opening 15 in the direction opposite to the Y direction (see FIG. 1). Hereinafter, the direction in which the retainer 20 slides detachably with respect to the connection end 12 is referred to as “sliding direction”. The retainer opening 15 is provided at the base end side of the lance 14 in the connection end 12 in the form of a groove extending in the Y direction corresponding to the sliding direction, and penetrates between the outside and the cavity 13.

The retainer opening 15 has an opposing surface 11b, at least a part of which closely faces the engagement portion 25 in the X direction when the retainer 20 is attached to the connection end 12. The opposing surface 11b has a rail-like guide 11c extending in the sliding direction.

The lock arm 16 has a portion that is continuous with an upper surface of the housing 10 as its base end, and extends in the X direction with the side to be fitted with the mating housing as its free end and elastically deforms in the Z direction by receiving an external force. When the housing 10 and the mating housing are fitted, the lock arm 16 engages with the locking portion of the mating housing to maintain the fitted state. The lock arm 16 is intended to be elastically deformed to release the engagement with the locking portion, thus releasing the fitting state between the housing 10 and the mating housing.

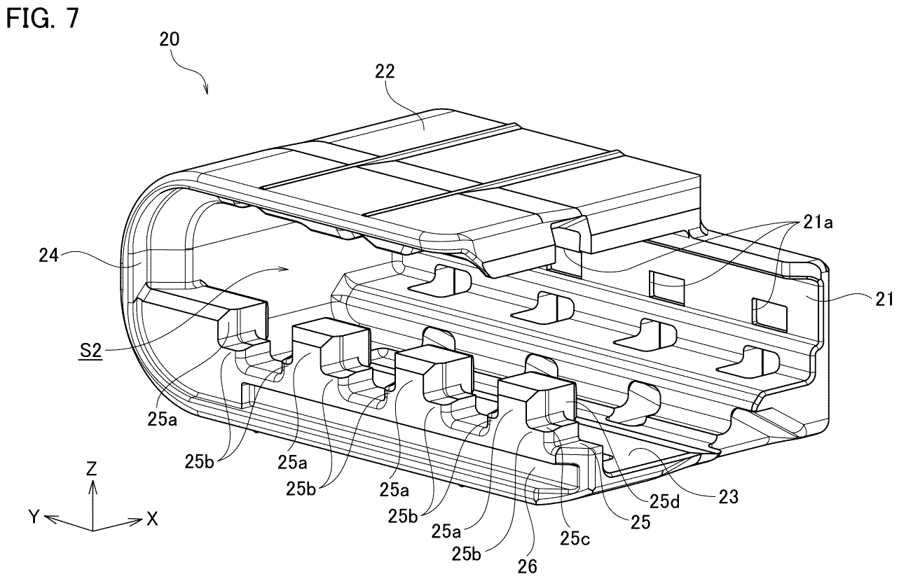

FIG. 7 is a perspective view of the retainer 20 viewed from a direction in which a connection space S2 accommodating the connection end 12 of the housing 10 can be visually recognized.

The retainer 20 is detachably attached to the housing 10 and locks the terminal metal part 100 accommodated in the cavity 13 when attached to the housing 10. In this embodiment, the retainer 20 is detachably attached to the connection end 12 which is a part of the housing 10, and locks the terminal metal part 100 when attached to the connection end 12. The retainer may be referred to as a “spacer”.

The retainer 20 is formed in a shape to accommodate at least a part of the connection end 12 in the connection space S2. In other words, the retainer 20 is attached to the connection end 12 to cover the connection end 12. In this embodiment, the retainer 20 has a shape of a case having a front wall 21, an upper surface wall 22, a bottom surface wall 23, and a side wall 24.

When the retainer 20 is attached to the connection end 12, the front wall 21 faces the tip end face 12a of the connection end 12 closely. The front wall 21 has at least a terminal insertion opening 21a at a position facing the connection opening 13b of each cavity 13.

The upper surface wall 22 closely faces the upper portion of the connection end 12 when the retainer 20 is attached to the connection end portion 12. The upper surface wall 22 is continuous with the upper end portion of the front wall 21.

The bottom wall 23 closely faces the lower portion of the connection end 12, that is, the lance 14 of each cavity 13, when the retainer 20 is attached to the connection end 12. The bottom wall 23 is continuous with the lower end of the front wall 21. The bottom wall 23 has the engagement portion 25 at least partially projecting toward the connection space S2 along a free end opposite a fixed end side which is continuous with the front wall 21. The engagement portion 25 has a groove portion 26 at a position facing the rail-like guide 11c provided in the retainer opening 15 when the retainer 20 is attached to the connection end 12. The groove portion 26 extends in the sliding direction and slidably engages with the rail-like guide portion 11c.

The side wall 24 closely faces one side of the connection end 12 when the retainer 20 is attached to the connection end 12. In this embodiment, assuming that the retainer 20 is attached to the connection end 12, the side wall 24 is continuous with the side ends of the front wall 21, the upper surface wall 22, and the bottom surface wall 23 viewed in the Y direction.

In the retainer 20, a space roughly enclosed by the inner surfaces of the front wall 21, the upper surface wall 22, the bottom surface wall 23, and the side wall 24 forms the connection space S2. The retainer 20 has no wall facing the front wall 21 across the connection space S2 except for the engagement portion 25, and has no wall facing the side wall 24 across the connection space S2. Therefore, an operator can attach the retainer 20 to the connection end 12 by sliding the retainer 20 in the direction opposite to the Y direction while inserting the engagement portion 25 into the retainer opening 15 provided in the connection end 12.

Furthermore, the retainer 20 has terminal holding parts 25a and reinforcing ribs 25b to form parts of the engagement portion 25.

The terminal holding parts 25a are provided corresponding to each cavity 13, and are a block-shaped convex portions that can move forward and backward into the internal space S1 of each cavity 13 in accordance with the sliding of the retainer 20. In this embodiment, there are four cavities 13, and there are four terminal holding parts 25a for the retainer 20 in the Y direction corresponding to the sliding direction in accordance with the spacing of the cavities 13 in parallel. Hereinafter, the direction in which the height of the terminal holding parts 25a and the reinforcing ribs 25b is defined is referred to as “height direction.” The height direction is orthogonal to both the accommodation direction and the sliding direction and corresponds to the Z direction in this embodiment.

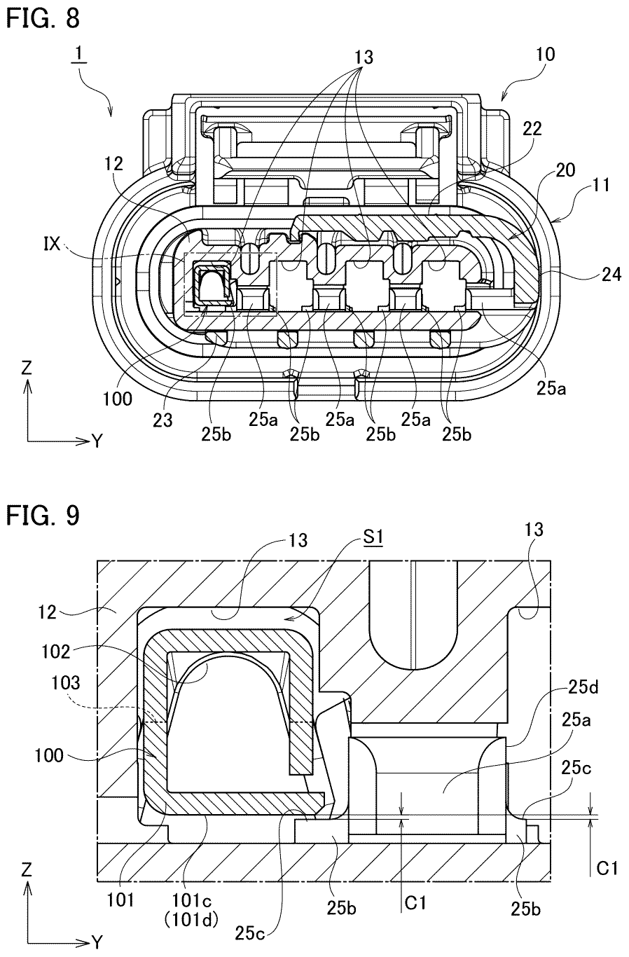

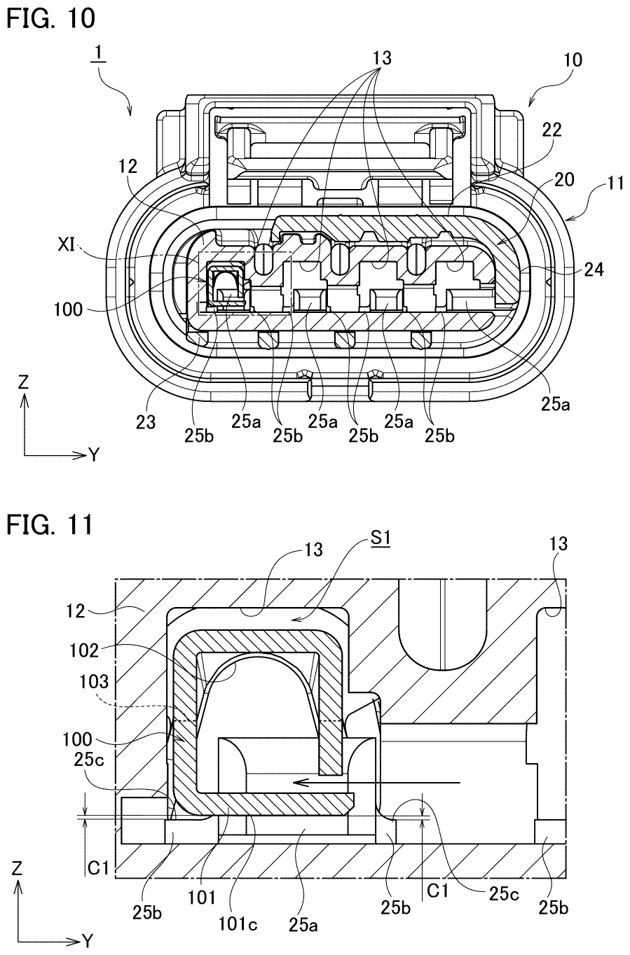

FIG. 8 is a cross-sectional view of the connector 1 when the retainer 20 is temporarily locked. The cut plane in FIG. 8 corresponds to the position of the X-X section in FIG. 5 and is the YZ plane passing directly in front of the terminal holding parts 25a, as in the case of the cut plane in FIG. 10, which is exemplified below. FIG. 9 is a partially enlarged view of the connector 1 corresponding to part IX in FIG. 8.

In the temporarily locked state of the retainer 20, the retainer 20 is attached to the connection end 12, which is a part of the housing 10, and the terminal holding parts 25a are not allowed to enter the internal space S1 of any of the cavities 13. Here, focusing on the terminal metal part 100 already accommodated in the cavity 13, the terminal holding part 25a does not face the locking surface 101b of the connection portion 101 in the X direction corresponding to the accommodation direction when the retainer 20 is in a temporarily locked state. In other words, the retainer 20 does not lock the terminal metal part 100 in the temporarily locked state, and the terminal metal part 100 detaches from the cavity 13 when the terminal metal part 100 is pulled in the direction opposite to the X direction, for example. When the internal space S1 of the cavity 13 is empty, the terminal metal part 100 can be inserted into the cavity 13 from the outside when the retainer 20 is in the temporarily locked state.

FIG. 10 is a cross-sectional view of the connector 1 when the retainer 20 is in the final locked state. The cut surface in FIG. 10 corresponds to the X-X section in FIG. 5 and is located on the YZ plane passing directly in front of each terminal holding part 25a. FIG. 11 is a partially enlarged view of the connector 1 corresponding to part XI in FIG. 10.

In the final locked state of the retainer 20, the retainer 20 is attached to the connection end 12 which is a part of the housing 10, and all the terminal holding parts 25a are in a final locked position in which the entrance into the internal space S1 of each corresponding cavity 13 has been completed. Here, focusing on the terminal metal part 100 already accommodated in the cavity 13, the terminal holding part 25a faces at least a part of the locking surface 101b of the connection portion 101 in the X direction, corresponding to the accommodation direction when the retainer 20 is in the final locked state. In other words, the retainer 20 locks the terminal metal part 100 in the final locked state, and the locking surface 101b comes into contact with the terminal holding part 25a when the terminal metal part 100 is pulled in the direction opposite to the X direction, for example, so that the terminal metal part 100 is not released from the cavity 13. When the internal space S1 of the cavity 13 is empty and the retainer 20 is in the final locked state, the terminal metal part 100 cannot be inserted into the cavity 13 from the outside because the traveling direction is blocked by the terminal holding part 25a entering the internal space S1.

The reinforcing ribs 25b are provided integrally with side surfaces 25d of the terminal holding parts 25a. Here, at least one of the two side surfaces of the terminal holding part 25a is formed as the side surface 25d, and the sliding direction is the normal direction of the two surfaces. In this embodiment, among the four terminal holding parts 25a, the terminal holding part 25a closest to the side wall 24 has only one side surface 25d facing the adjacent terminal holding part 25a. Note that the terminal holding part 25a having only one side surface 25d is structurally stronger than the other terminal holding parts 25a because the side opposite to the side surface 25d is integrated with the side wall 24. However, the other three terminal holding parts 25a are provided with reinforcing ribs 25b on both side surfaces 25d.

In order to improve the strength of the terminal holding part 25a, the length of the reinforcing rib 25b in the X direction is preferably set as long as possible to the extent that it does not inhibit entry of the engagement portion 25 into the retainer opening 15.

Here, in the Z direction corresponding to the height direction, a minimum distance C1 is defined among the distances between an upper surface 25c of the reinforcing rib 25b and a lower end 101d of the locking surface 101b of the terminal metal part 100 accommodated in the cavity 13. In this case, the upper surface 25c of the reinforcing rib 25b is set so that the minimum distance C1 is the minimum within an allowable range in which the accommodation of the terminal metal part 100 is not prevented. Even if a part of the reinforcing rib 25b enters the internal space S1 when the retainer 20 is in the temporarily locked state, the movement of the terminal metal part 100 in the accommodation direction is not restricted.

In addition, an outer surface closest to the lance 14 is defined as an outer surface 101c of the connection portion 101 of the terminal metal part 100 accommodated in the cavity 13. A lower end 101d of the locking surface 101b is also an end of the outer surface 101c. It is assumed that when the retainer 20 is in the temporarily locked state, a part of the reinforcing rib 25b enters the internal space S1 and the connection portion 101 of the terminal metal part 100 passes over the upper surface 25c of the reinforcing rib 25b. At this point, since the minimum distance C1 is set to be the minimum within the allowable range, the outer surface 101c of the connection portion 101 and the upper surface 25c of the reinforcing rib 25b can be brought close to each other. In other words, the height of the upper surface 25c of the reinforcing rib 25b can be set high enough to be close to the outer surface 101c.

In this embodiment, in the terminal holding parts 25a with the reinforcing ribs 25b provided on both side surfaces 25d, the width in the Y direction corresponding to the sliding direction differs for each reinforcing rib 25b. The width of the reinforcing rib 25b may be set, as appropriate, according to the condition that, for example, the entrance of the locking portion 101a of the terminal metal part 100 projecting outward is not prevented when the terminal metal part 100 is accommodated in the cavity 13.

Thus, in this embodiment, the terminal metal part 100 accommodated in the cavity 13 is locked by the terminal holding part 25a of the retainer 20, and also by the lance 14 as a locking member separate from the terminal holding part 25a. Therefore, the locking of the terminal metal part 100 by the lance 14 may be called “primary locking” and the locking of the terminal metal part 100 by the terminal holding part 25a may be called “secondary locking.” The connector 1 has a double locking mechanism that realizes double locking by the primary locking and the secondary locking.

The packing 30 is an annular elastic body attached to the base of the connection end 12 facing the fitting opening 11a in the housing 10. By providing the packing 30, the housing body 11 is fitted more closely to the mating housing when the connector 1 is fitted to the mating connector.

### Next, the Action and Effect of the Connector 1 Will Be Described.

Firstly, the connector 1 includes the housing 10 having the cavity 13 for accommodating the terminal metal part 100, and the retainer 20 slidably attachable and detachable to and from the housing 10 in a direction orthogonal to an accommodation direction of the terminal metal part 100. The retainer includes the block-shaped terminal holding part 25a which is freely movable in and out of the internal space S1 of the cavity 13 in accordance with sliding of the retainer 20 and which locks the terminal metal part 100 when facing the locking surface 101b forming a part of the terminal metal part 100 in the accommodation direction. The retainer 20 further includes the reinforcing rib 25b provided integrally with the side surface 25d of the terminal holding part 25a, the sliding direction being the normal direction of the side surface 25d. The height direction in which the height of the terminal holding part 25a and the reinforcing rib 25b is defined is orthogonal to both the accommodation direction and the sliding direction. The upper surface 25c of the reinforcing rib 25b is set so that the minimum distance C1 in the height direction between the upper surface 25c and the lower end 101d of the locking surface 101b of the terminal metal part 100 accommodated in the cavity 13 is set to be the minimum within an allowable range in which the accommodation of the terminal metal part 100 is not prevented.

Here, the accommodation direction of the terminal metal part 100 with respect to the cavity 13 corresponds to the X direction as illustrated above. The sliding direction of the retainer 20 with respect to the housing 10 corresponds to the Y direction as illustrated above. The height direction in which the height of the terminal holding part 25a and the reinforcing rib 25b is defined corresponds to the Z direction as illustrated above.

According to the connector 1 having the configuration above, the reinforcing rib 25b is provided integrally with the terminal holding part 25a of the retainer 20. Then, as described above, the height position of the upper surface 25c of the reinforcing rib 25b can be set high as to be close to the lower end 101d of the locking surface 101b, which is a part of the terminal metal part 100.

Here, with reference to FIG. 6, it is assumed that the terminal metal part 100 accommodated in the cavity 13 and secondly locked by the terminal holding part 25a is pulled in the direction in which the terminal metal part 100 is released from the cavity 13 by an external force, that is, in the direction opposite to the X direction. In this case, the lower end 101d of the locking surface 101b of the terminal metal part 100 contacts and presses against the terminal holding part 25a, and the terminal holding part 25a which is indirectly subjected to an external force imparts a force as indicated by the black arrow in FIG. 6 to a part of the housing 10. At this point, as described above, the height position of the upper surface 25c of the reinforcing rib 25b is set high in this embodiment, so that the height position at which the terminal holding part 25a contacts a part of the housing 10 is also high. As illustrated in FIG. 6, a part of the housing 10 with which the terminal holding part 25a subjected to external force contacts is a first contact position P1 set on the opposing surface 11b. The height position of the first contact position P1 is equivalent to the height position of the upper surface 25c of the reinforcing rib 25b, considering deformation of the terminal holding part 25a due to external force. In other words, the difference between the height position of the lower end 101d corresponding to the height position at which the terminal holding part 25a receives external force from the terminal metal part 100, and the height position of the first contact position P1 at which an external force is exerted on the housing 10 is approximately the minimum distance C1. Therefore, the deformation of the terminal holding part 25a due to an external force is reduced to a small inclination to the rear due to the difference in the height position defined by the minimum distance C1.

As a comparative example, it is assumed that the retainer 20 includes the terminal holding part 25a, but does not include the reinforcing rib 25b. In this case, a part of the housing 10 contacted by the terminal holding part 25a receiving external force takes a second contact position P2, which is set on the opposing surface 11b and is different from the first contact position P1. The height position of the second contact position P2 is equivalent to the height position of a root surface 125c of the terminal holding part 25a of the engagement portion 25. As illustrated in FIG. 6, the root surface 125c is indicated by an imaginary line. In the terminal holding part 25a, the difference between the height position of the lower end 101d corresponding to the height position at which the external force is received from the terminal metal part 100, and the height position of the second contact position P2 at which the external force is exerted on the housing 10, is indicated as a virtual distance C2. As described above, in the comparative example, the virtual distance C2 becomes larger due to the absence of the reinforcing ribs 25b, and as a result, the deformation of the terminal holding part 25a due to the external force may show a large inclination toward the rear due to the difference in the height position defined by the virtual distance C2.

As described above, according to the present embodiment, it is possible to provide the connector 1 which reduces the deformation of the terminal holding part 25a of the retainer 20 due to the external force. Reducing the deformation of the terminal holding part 25a means that the terminal holding force by the terminal holding part 25a is easily maintained.

Further, it is assumed that the retainer 20 is in the temporary locking position in which the terminal holding part 25a is not allowed to enter the internal space S1 of the cavity 13 while being attached to the housing 10. At this point, in the connector 1, the upper surface 25c of the reinforcing rib 25b may face at least a part of the terminal metal part 100 which is not yet fully accommodated in the cavity 13 in the height direction.

In this case, as illustrated in FIG. 9, when the retainer 20 is in the temporary locking state and the terminal metal part 100 is inserted into the cavity 13, a part of the terminal metal part 100 comes close to the upper surface 25c of the reinforcing rib 25b. Therefore, with the connector 1, the reinforcing rib 25b can be used as a guide member by inserting the terminal metal part 100 into the cavity 13 while a part of the terminal metal part 100 is brought into contact with the upper surface 25c. The reinforcing rib 25b is used as a guide member in this way, so that the terminal metal part 100 is prevented from being caught by any part of the cavity 13 when the terminal metal part 100 is inserted into the cavity 13, for example, and the assembling workability of the connector 1 can be improved.

In the above description, the housing 10 includes four cavities 13, and the terminal metal part 100 is connected to one of the cavities 13. However, the number of the cavities 13 included in the housing 10 or the number of the terminal metal parts 100 connected to the cavities 13 is optional.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A connector comprising:
a housing having a cavity for accommodating a terminal metal part and
a retainer slidably attachable and detachable to and from the housing in a sliding direction orthogonal to an accommodation direction of the terminal metal part, wherein:
the retainer includes a block-shaped terminal holding part which is freely movable in and out of an internal space of the cavity in accordance with sliding of the retainer, and which locks the terminal metal part when facing a locking surface forming a part of the terminal metal part in the accommodation direction; and a reinforcing rib provided integrally with a side surface of the terminal holding part, the sliding direction being the normal direction of the side surface,
a height direction in which the heights of the terminal holding part and the reinforcing rib are defined is orthogonal to both the accommodation direction and the sliding direction, and
an upper surface of the reinforcing rib is set so that a minimum distance in the height direction between the upper surface and a lower end of the locking surface of the terminal metal part accommodated in the cavity is set to be the minimum within an allowable range in which accommodation of the terminal metal part is not prevented.

2. The connector according to claim 1, wherein the upper surface of the reinforcing rib faces at least a part of the terminal metal part which is not yet fully accommodated in the cavity in the height direction when the retainer is attached to the housing and is in a temporarily locked position in which the terminal holding part is not allowed to enter the internal space of the cavity.
